(19) United States
(12) Patent Application Publication
(10) Pub. No.: US 2026/0089753 A1
(43) Pub. Date: Mar. 26, 2026

(54) Coexistence Solutions for 802.11 Operations

(71) Applicant: Apple Inc., Cupertino, CA (US)

(72) Inventors: Abdel Karim AJAMI, San Jose, CA (US); Anuj BATRA, Redwood City, CA (US); Chittabrata GHOSH, San Jose, CA (US); Leonid EPSTEIN, Netanya (IL); Morteza MEHRNOUSH, Hayward, CA (US); Neelakantan NURANI KRISHNAN, San Diego, CA (US); Qi WANG, Mountain View, CA (US); Yoel BOGER, Shoham (IL); Yong Ho SEOK, Cupertino, CA (US); Yong LIU, Campbell, CA (US); Zhou LAN, San Jose, CA (US)

(21) Appl. No.: 19/335,991

(22) Filed: Sep. 22, 2025

Related U.S. Application Data
(60) Provisional application No. 63/699,299, filed on Sep. 26, 2024.

(51) Int. Cl. H04W 74/04; H04W 52/02; H04W 56/00

(52) U.S. Cl. CPC H04W 74/04; H04W 52/0216; H04W 56/00

(57) ABSTRACT

An apparatus configured to determine a transmission opportunity (TXOP) for transmitting to a station, process, based on signaling received from the station, an indication comprising an unavailability start time and an unavailability duration that occurs during the TXOP and perform an operation related to the TXOP based on the indication.

### PRIORITY/INCORPORATION BY REFERENCE

This application claims priority to U.S. Provisional Application Ser. No. 63/699,299 filed on Sep. 26, 2024, and entitled “Coexistence Solutions for 802.11 Operations,” the entirety of which is incorporated by reference herein.

### BACKGROUND

IEEE 802.11 networks may experience coexistence (COEX) scenarios with other communication protocols, e.g., Bluetooth, cellular, ultra-wideband (UWB), etc. These COEX scenarios may cause issues for stations attempting to transmit or receive signals via the 802.11 networks. Addressing various COEX scenarios will mitigate issues, such as interference, that may arise.

### SUMMARY

Some example embodiments are related to an apparatus having processing circuitry coupled to memory, wherein the processing circuitry is configured to determine a transmission opportunity (TXOP) for transmitting to a station, process, based on signaling received from the station, an indication comprising an unavailability start time and an unavailability duration that occurs during the TXOP and perform an operation related to the TXOP based on the indication.

Other example embodiments are related to an apparatus having processing circuitry coupled to memory, wherein the processing circuitry is configured to process, based on signaling received from a station, an initial control frame (ICF) comprising information related to a transmission opportunity (TXOP) for the station, determine unavailability information comprising an unavailability start time and an unavailability duration that occurs during the TXOP and generate, for transmission to the station, an indication comprising the unavailability information.

### BRIEF DESCRIPTION OF THE DRAWINGS

FIG. 1 shows an example arrangement of a wireless communication device and a wirelessly locatable tag according to various example embodiments.

FIG. 2 shows an example wireless communication device according to various example embodiments.

FIG. 3 shows a first example signaling diagram for transmission opportunity (TXOP) operations according to various example embodiments.

FIG. 4 shows an example signaling diagram where the TXOP holder dynamically adjusts the TXOP when receiving unavailability information from the TXOP responder according to various example embodiments.

FIG. 5 shows an example signaling diagram where the TXOP holder dynamically ends the TXOP when receiving unavailability information from the TXOP responder according to various example embodiments.

FIG. 6 shows an example signaling diagram where the TXOP holder transmits data during the TXOP when receiving unavailability information from the TXOP responder according to various example embodiments.

FIG. 7 shows a first example signaling diagram where the TXOP responder sends a frame to a TXOP holder indicating a power mode/state into which the TXOP responder is placed after unavailability period according to various example embodiments.

FIG. 8 shows a second example signaling diagram where the TXOP responder sends a frame to a TXOP holder indicating a power mode/state into which the TXOP responder is placed after unavailability period according to various example embodiments.

FIG. 9 shows an example signaling diagram where the TXOP holder determines an unavailability start time based on information sent by the TXOP responder according to various example embodiments.

### DETAILED DESCRIPTION

The example embodiments may be further understood with reference to the following description and the related appended drawings, wherein like elements are provided with the same reference numerals. The example embodiments relate to operations performed by a transmission opportunity (TXOP) holder station and/or a TXOP responder station when the TXOP responder station indicates that it will be unavailable for at least some time during the TXOP.

The example embodiments are described with reference to the IEEE 802.11 communication protocols for devices to communicate via wireless connections. There are multiple releases of the 802.11 protocols (e.g., 802.11ax, 802.11be, 802.11bn, etc.). Reference to 802.11 in the example embodiments may refer to any release of the 802.11 protocols unless a specific release is identified in the description.

The example embodiments are described with regard to a wireless communication device. Typically, a wireless communication device in an 802.11 network may be referred to as a station (or STA). In the example embodiments, a station may refer to an end point device such as a mobile phone, tablet computer, desktop computer, smartphone, embedded device, wearable, Internet of Things (IoT) device, video game console, media player, entertainment device, smart speakers, smart TV, streaming devices, etc. The station may also refer to intermediate points in the 802.11 network including access points (APs), routers, switches, etc. Thus, any reference to a station or wireless communication device in the example embodiments may refer to any device capable of wirelessly communicating using the 802.11 protocol, unless otherwise stated.

The example embodiments are described with reference to a TXOP responder station sending unavailability information in an initial control response (ICR). The TXOP responder station may send unavailability information to the TXOP holder in one or more other messages beside the ICR. The example embodiments are not limited to unavailability information being provided in an ICR but may be implemented regardless of the manner that the unavailability information is reported.

The example embodiments provide various aspects for handling COEX scenarios for TXOP holders and TXOP responders. The aspects include TXOP holder behavior based on availability/unavailability information received from a TXOP responder, blindness of the TXOP responder due to COEX, a triggered uplink (UL) Acknowledgment (Ack) policy and failures due to COEX. Each of these example aspects will be described in greater detail below.

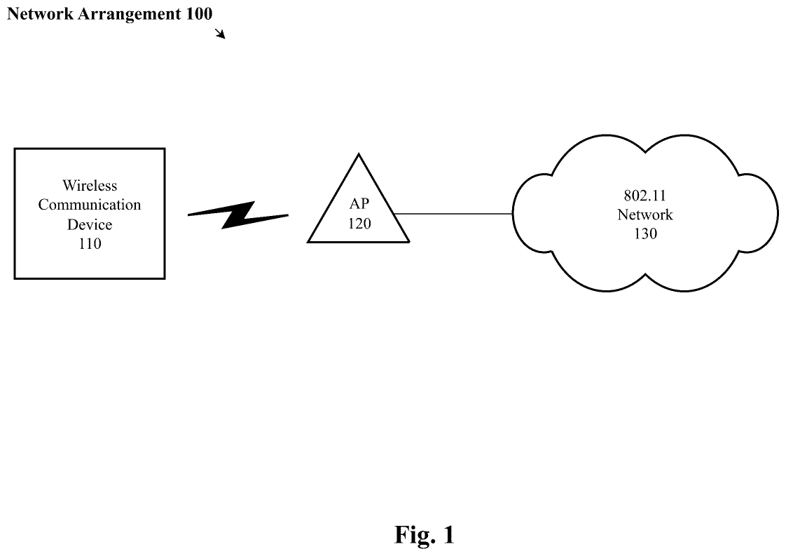

FIG. 1 shows an example arrangement 100 of a wireless communication device 110 (e.g., a non-AP station) communicating with an AP station 120 to access an 802.11 network 130. The wireless communication device 110 may represent any type of electronic component that is capable of communicating with the AP 120. Specific examples of the wireless communication device 110 include, but are not limited to, mobile phones, tablet computers, desktop computers, smartphones, embedded devices, wearables, Internet of Things (IoT) devices, video game consoles, media players, entertainment devices, smart speakers, smart TVs, streaming devices, etc.

The wireless communication device 110 may be configured to communicate with one or more networks. In the example of the network arrangement 100, the network with which the wireless communication device 110 may wirelessly communicate is an 802.11 network 130. The wireless communication device 110 may also communicate with other types of networks (e.g., 5G networks, 5G cloud RAN, a next generation RAN (NG-RAN), a legacy cellular network, etc.) and the wireless communication device 110 may also communicate with networks over a wired connection. With regard to the example embodiments, the wireless communication device 110 may establish a connection with the 802.11 network 130. Therefore, the wireless communication device 110 may have an Industrial, Scientific and Medical (ISM) chipset to communicate with the 802.11 network 130.

Any association procedure may be performed for the wireless communication device 110 to connect to the 802.11 network 130. The wireless communication device 110 may associate with an AP 120 to access the 802.11 network 130

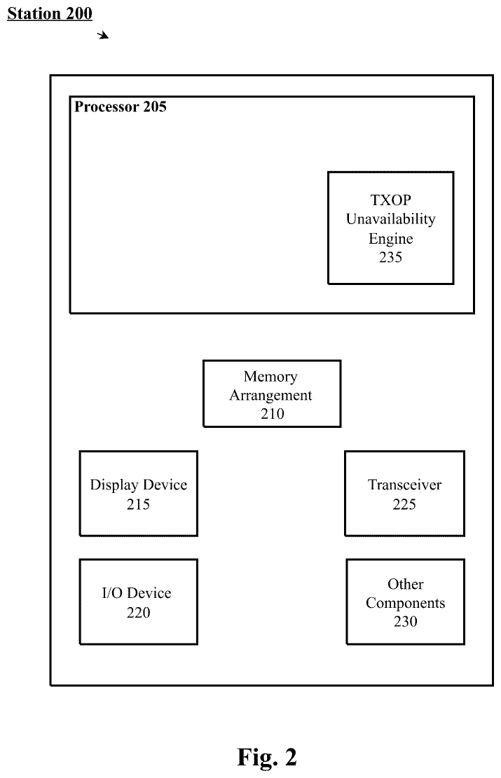

FIG. 2 shows an example station 200 according to various example embodiments. The example station 200 may represent the wireless communication device 110 or the AP 120 of the network arrangement 100. While various components are described below for the station 200, there is no requirement that a station have all the described components. For example, an AP will typically not include a display device.

The station 200 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the station 200 to other electronic devices, etc.

The processor 205 may be configured to execute a plurality of engines of the station 200. For example, the engines may include a TXOP Unavailability engine 235. The TXOP Unavailability engine 235 may be configured to perform operations related to unavailability of stations during a TXOP. These operations may include operations performed by a TXOP holder or a TXOP responder. These operations will be described in greater detail below.

The above referenced engine being an application (e.g., a program) executed by the processor 205 is only an example. The functionality associated with the engines may also be represented as a separate incorporated component of the station 200or may be a modular component coupled to the station 200, e.g., an integrated circuit with or without firmware. For example, the integrated circuit may include input circuitry to receive signals and processing circuitry to process the signals and other information. The engines may also be embodied as one application or separate applications. In addition, in some stations, the functionality described for the processor 205 is split among two or more processors such as a baseband processor and an applications processor. The example embodiments may be implemented in any of these or other configurations of a wireless communication device.

The memory arrangement 210 may be a hardware component configured to store data related to operations performed by the station 200. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the wirelessly locatable tag or any other wireless communication device. Accordingly, the transceiver 225 may operate on a variety of different frequencies or channels (e.g., set of consecutive frequencies). For example, the transceiver may be configured to operate on frequencies associated with the IEEE 802.11 protocols to exchange signals with other station operating on these protocols. The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals for implementing any one of the methods described herein.

A first aspect of the example embodiments relate to operations performed by a transmission opportunity (TXOP) holder based on availability/unavailability information provided by the TXOP responder. TXOP enables a station to transmit multiple frames consecutively within a burst after the station gains the channel.

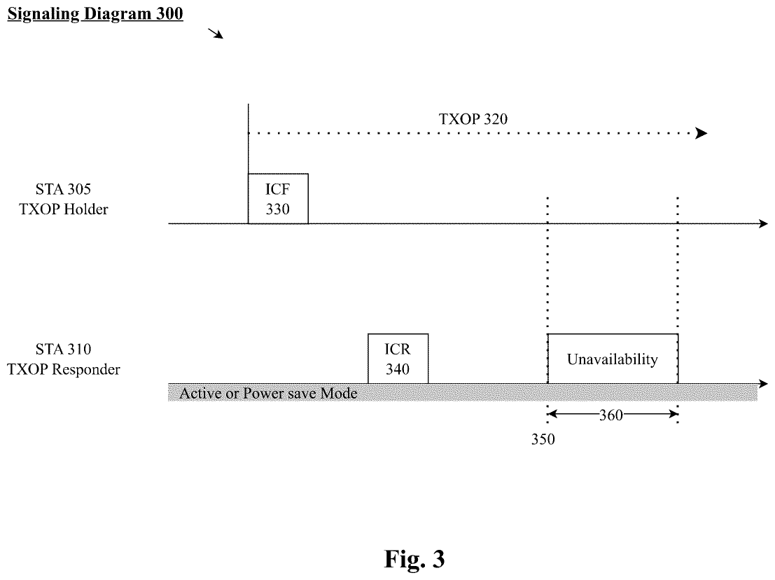

FIG. 3 shows an example signaling diagram 300 for transmission opportunity (TXOP) operations according to various example embodiments. In the example of FIG. 3, the signaling is performed between a TXOP holder (e.g., station 305) and a TXOP responder (e.g., station 310).

In the example of FIG. 3, the station 305 may gain access to the channel for the duration of the TXOP 320. The station 305 may then transmit an initial control frame (ICF) 330. The information included in the ICF 330 may include the duration of the TXOP 320, e.g., the network allocation vector (NAV) that signals other stations as to the duration of the TXOP 320 so that other stations do not attempt to access the channel during this duration. Other information that may be defined by standard may also be included in the ICF 330 but is not further described herein.

The station 310 may receive the ICF 330 and respond with an initial control response (ICR) 340. The ICR 340 may include an unavailability start time and an unavailability duration for the station 310 that occurs during the TXOP 320. For example, the station 310 may have Bluetooth communications scheduled during the TXOP 320. In the example of FIG. 3, the unavailability start time is shown at 350 and the unavailability duration is shown as 360. The unavailability duration used by the TXOP responder station in the ICR 340 may be shorter up to the availability duration or may be set based on the ICF duration (e.g., TXOP duration).

The station 305 receives the ICR 340 with the unavailability information for the station 310. The station 305 then may decide what to do with the TXOP 320 where the station 310 does not have availability to receive communications from the station 305 during at least a portion of the TXOP 320. The example embodiments provide various operations for the TXOP holder station 305 to perform in this scenario.

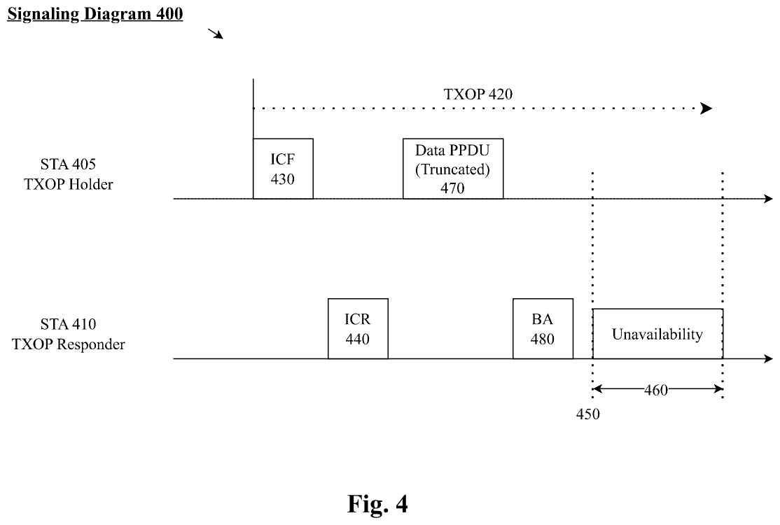

In some example embodiments, the TXOP holder may dynamically adjust the TXOP. FIG. 4 shows an example signaling diagram 400 where the TXOP holder dynamically adjusts the TXOP when receiving unavailability information from the TXOP responder according to various example embodiments. The signaling diagram 400 is similar to the signaling diagram 300. The TXOP holder station 405 transmits an ICF 430 including the duration of the TXOP 420. The TXOP responder station 410 transmits an ICR 440 in response to the ICF 430 that includes an unavailability start time 450 and an unavailability duration 460 during the TXOP 420.

As stated above, in some example embodiments the TXOP holder station 405 may dynamically adjust the TXOP 420 based on the unavailability start time 450 and/or unavailability duration 460 provided in the ICR 440. For example, as shown in FIG. 4, the TXOP holder station 405 may generate a truncated data physical layer protocol data unit (PPDU) 470 that is to be transmitted to the TXOP responder station 410. The truncated data PPDU 470 may be transmitted during the TXOP 420 such that it is completed prior to the unavailability start time 450 and such that it leaves enough time for the TXOP responder station 410 to transmit a block acknowledgement (BA) 480 acknowledging the truncated data PPDU 470.

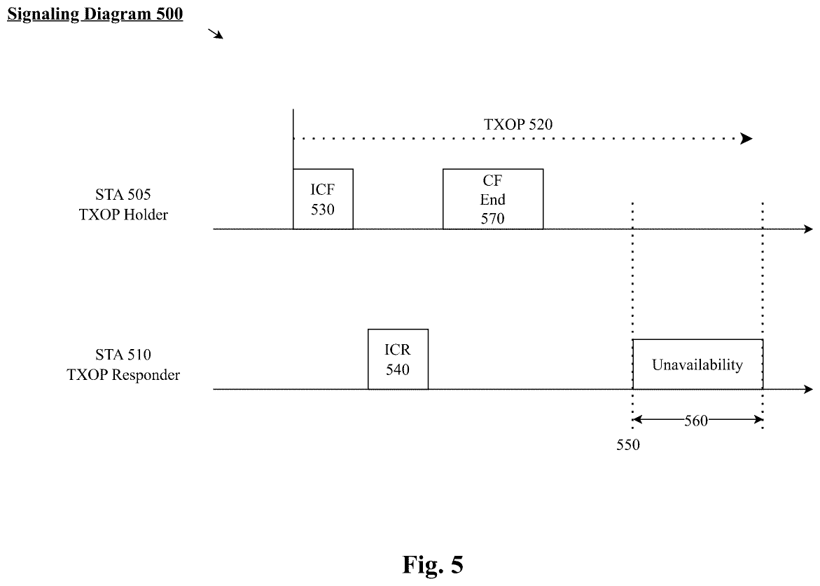

FIG. 5 shows an example signaling diagram 500 where the TXOP holder dynamically ends the TXOP when receiving unavailability information from the TXOP responder according to various example embodiments. The signaling diagram 500 is similar to the signaling diagram 300. The TXOP holder station 505 transmits an ICF 530 including the duration (e.g., NAV) of the TXOP 520. The TXOP responder station 510 transmits an ICR 540 in response to the ICF 530 that includes an unavailability start time 550 and an unavailability duration 560 during the TXOP 520.

In this example embodiment, the TXOP holder station 505 may send a contention free (CF) end transmission 570 indicating that the NAV is reset, e.g., other stations may contend for the channel.

In some example embodiments, when the TXOP holder station 505 is an AP, the AP may schedule other stations (e.g., not the TXOP responder 510) in the TXOP 520.

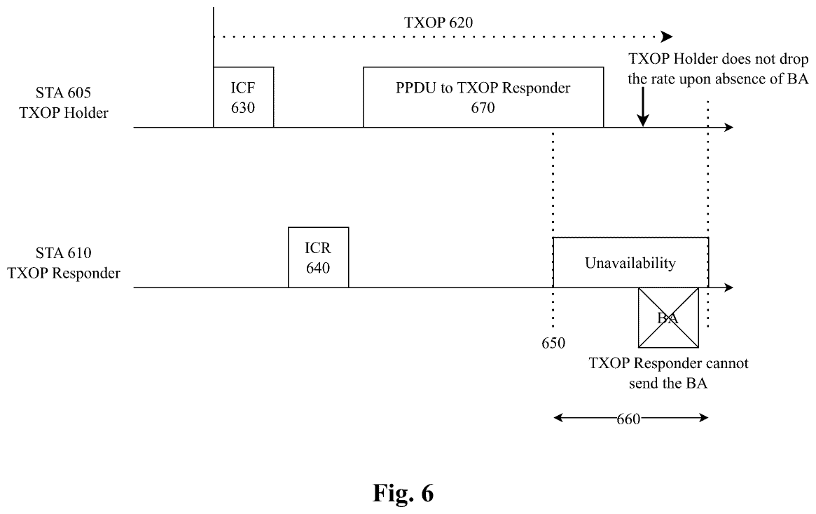

FIG. 6 shows an example signaling diagram 600 where the TXOP holder transmits data during the TXOP when receiving unavailability information from the TXOP responder according to various example embodiments. The signaling diagram 600 is similar to the signaling diagram 300. The TXOP holder station 605 transmits an ICF 630 including the duration (e.g., NAV) of the TXOP 620. The TXOP responder station 610 transmits an ICR 640 in response to the ICF 630 that includes an unavailability start time 650 and an unavailability duration 660 during the TXOP 620.

In this example embodiment, the TXOP holder station 605 transmits the data PPDU 670 to the TXOP responder station 610 even though some or all of the transmission occurs during the unavailability duration 660. Because the TXOP responder station 610 is unavailable during the unavailability duration 660, the TXOP responder station 610 may not send a BA acknowledging the data PPDU 670. In legacy operations, when the TXOP holder station 605 does not receive a BA corresponding to a data PPDU transmission, the TXOP holder station 605 may assume that there is an issue with the channel. Thus, in response, the TXOP holder station 605 may perform operations that are designed to make it more likely that transmission of the data PPDU 670 is successful. These operations may include, for example, dropping the transmission rate, increasing the contention window (CW) size for the access category (AC) of the PPDU or the QoS retry counters (QSRC) of the AC of the PPDU. These operations may make it more likely that the data PPDU transmission is successful but there may be a performance penalty for the TXOP holder station 605, e.g., the lower transmission rate results in a lower throughput, etc.

However, in the current scenario, the TXOP holder station 605 may determine that the BA was not received because the TXOP responder 610 was unavailable rather than because of an issue with the channel. Thus, in these example embodiments, the TXOP holder station 605 may not perform any operations related to make it more likely that transmission of the data PPDU 670 is successful, e.g., the rate, CW and QSRC may remain the same. This is because the lack of a BA is not based on channel conditions but is based on the unavailability of the TXOP responder station 610. Thus, the TXOP holder station 605 will not experience a performance penalty.

A second aspect of the example embodiments relate to power save operations of a TXOP responder station that indicates it is unavailable. A station may operate in various power modes. These modes include an active mode and a power save mode. The power save mode includes two states, an awake state and a doze state. The operations performed by a station when in these different modes/states are defined by standard and are not further described herein.

The example embodiments address issues associated with a TXOP responder station indicating unavailability. For example, when the TXOP holder station receives an unavailability indication from a TX responder station, the TXOP holder station may not be aware of the power mode/state that the TX responder station will be in when the TXOP responder station becomes available after the unavailability.

In some example embodiments, a TXOP holder that receives an unavailability indication from a TXOP responder (e.g., in an ICR) may determine that the TXOP responder is unavailable, e.g., is placed in the power save mode and doze state or is not available to receive transmissions from the TXOP holder at the start of the unavailability duration. For example, referring to FIG. 3, regardless of the power mode/state of the TXOP responder station 310 prior to the unavailability start 350, when the TXOP responder station 310 is in the unavailability duration 360, the TXOP holder may assume the TXOP responder station 310 is unavailable. When the TXOP responder station 310 exits the unavailability duration 360, the TXOP holder station 305 may determine that the TXOP responder station 310 is placed in the power mode/state that the TXOP responder station 310 was in prior to the unavailability start 350, e.g., after the unavailability duration, a TXOP responder station is placed into the power mode/state it was in prior to the unavailability duration.

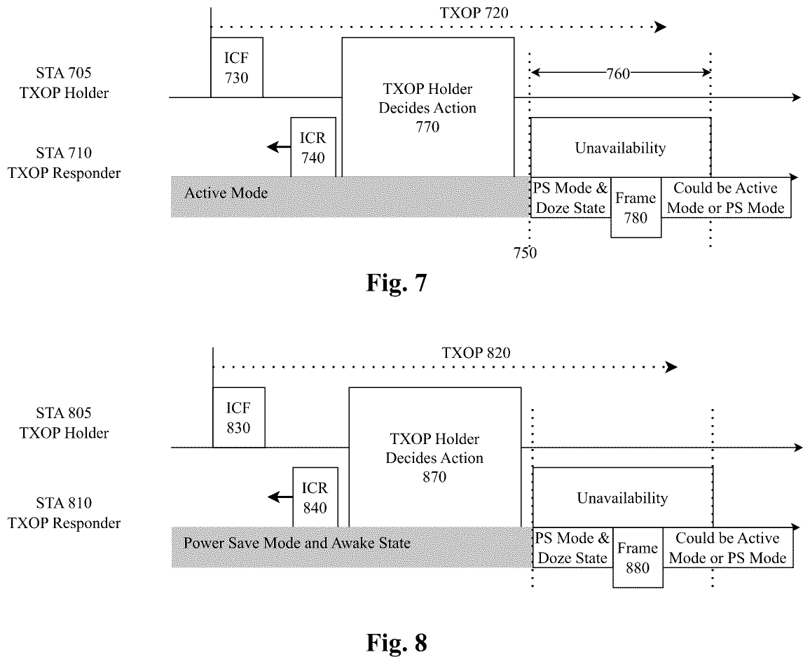

In other example embodiments, the TXOP responder station may transmit a frame to the TXOP holder during the unavailability duration. This frame may include power mode/state information describing the power mode/state into which the TXOP responder will be placed when the unavailability duration ends, e.g., the TXOP holder may receive an explicit indication of the power mode/state into which the TXOP responder is placed after the unavailability duration. These embodiments are described in further detail below with reference to FIGS. 7 and 8.

The example embodiments of the frame providing the power mode/state information or the TXOP holder determining the TXOP responder will be placed into the power mode/state it was in prior to the unavailability duration are not mutually exclusive. For example, the TXOP holder may determine the TXOP responder will be placed into the power mode/state it was in prior to the unavailability duration unless it receives a frame with different information from the TXOP responder.

FIG. 7 shows a first example signaling diagram 700 where the TXOP responder sends a frame to a TXOP holder indicating a power mode/state into which the TXOP responder is placed after unavailability period according to various example embodiments. The signaling diagram 700 is similar to the signaling diagram 300. The TXOP holder station 705 transmits an ICF 730 including the duration (e.g., NAV) of the TXOP 720. The TXOP responder station 710 transmits an ICR 740 in response to the ICF 730 that includes an unavailability start time 750 and an unavailability duration 760 during the TXOP 720. Based on receiving the ICR 740 with the unavailability information, the TXOP holder station 705 may perform an action 770. For example, the actions may be any of the example operations described above with reference to the first aspect of the example embodiments. However, the action 770 is not limited to these example operations.

In this example embodiment, the TXOP responder station 710 is in the active power mode up until the unavailability start time 750. At the start of the unavailability duration 760, the TXOP responder station 710 is placed into the doze state of the power save mode. However, the TXOP responder station 710 may transmit a frame 780 during the unavailability duration 760. The frame 780 may indicate that the TXOP responder station 710 is available (e.g., the TXOP responder station 710 may have completed its Bluetooth communications prior to the unavailability duration 760 ending). The frame 780 may also indicate a power mode/state of the TXOP responder station 710. This power mode/state may be any of the power modes described above, e.g., active mode, power save mode awake state, power save mode doze state. When the TXOP holder station 705 receives the frame 780 with the power mode/state information, the TXOP holder station 705 may determine that the TXOP responder station 710 will be in the power mode/state indicated in the frame 780 from the time that the frame 780 is received as shown in FIG. 7.

FIG. 8 shows a second example signaling diagram 800 where the TXOP responder sends a frame to a TXOP holder indicating a power mode/state into which the TXOP responder is placed after unavailability period according to various example embodiments. The signaling diagram 800 is similar to the signaling diagram 300. The TXOP holder station 805 transmits an ICF 830 including the duration (e.g., NAV) of the TXOP 820. The TXOP responder station 810 transmits an ICR 840 in response to the ICF 830 that includes an unavailability start time 850 and an unavailability duration 860 during the TXOP 820. Based on receiving the ICR 840 with the unavailability information, the TXOP holder station 805 may perform an action 870. For example, the actions may be any of the example operations described above with reference to the first aspect of the example embodiments. However, the action 870 is not limited to these example operations.

In this example embodiment, the TXOP responder station 810 is in the power save mode and awake state up until the unavailability start time 850. At the start of the unavailability duration 860, the TXOP responder station 810 is placed into the doze state of the power save mode. However, the TXOP responder station 810 may transmit a frame 880 during the unavailability duration 860. The frame 880 may indicate that the TXOP responder station 810 is available (e.g., the TXOP responder station 810 may have completed its Bluetooth communications prior to the unavailability duration 860 ending). The frame 880 may also indicate a power mode/state of the TXOP responder station 810. This power mode/state may be any of the power modes described above, e.g., awake mode, power save mode active state, power save mode doze state. When the TXOP holder station 805 receives the frame 880 with the power mode/state information, the TXOP holder station 805 may determine that the TXOP responder station 810 will be in the power mode/state indicated in the frame 880 from the time that the frame 880 is received as shown in FIG. 8.

In a third aspect, the example embodiments are related to unavailability information maintenance. In these example embodiments a station (e.g., an AP) may maintain an unavailability state for a peer station (e.g., a non-AP station). In some example embodiments, when the AP is a multi-link device (MLD), the unavailability state may apply at the link level (e.g., there is an unavailability state for each individual link of the MLD). In other example embodiments, when the AP is an MLD, the unavailability state may apply at the MLD level (e.g., the unavailability state applies to all links of the MLD).

In some example embodiments, the links to which the unavailability information applies may be identified during the ICF/ICR exchange. In other example embodiments, the unavailability information may apply to the link where the frame carrying the unavailability information (e.g., the link on which the ICR is sent).

In some example embodiments, as was described above with reference to FIGS. 7 and 8, a station may send a frame during the time that overlaps with the unavailability duration to indicate that the station is available. As described above, the station may determine that communications on a COEX protocol are completed and therefore the remaining portion of the unavailability duration may be cancelled. For example, the station may send a frame that sets an unavailability duration field to 0 indicating that the unavailability is cancelled. In a similar manner, a station may also send a frame that updates previously indicated unavailability information, e.g., extends or shortens the unavailability duration.

In a fourth aspect of the example embodiments, issues related to station blindness are addressed. Station blindness may be when a station loses synchronization with the medium. This may occur because the station experienced unavailability, e.g., the station experienced in-device COEX. The example embodiments provide operations for handling the station blindness.

In some example embodiments, when exiting the unavailability duration, the station may implement a NAV Sync Delay. The NAV Sync delay may be a delay to be used prior to transmitting when exiting the unavailability duration if no frame is detected by which the NAV may be set. This delay may be, for example, the maximum duration of a PPDU. For example, referring to FIG. 3, at the end of the unavailability duration 360, the TXOP responder station 310 may determine if it has detected a frame that may be used to set a NAV. If no such frame has been detected, the TXOP responder station 310 may wait the duration of the NAV Sync delay prior to transmitting on the medium. The value of the NAV Sync delay may be set via a master information block (MIB) broadcast by the network.

In other example embodiments, a station exiting the unavailability duration may perform a medium access recovery procedure. The medium access recovery procedure generally includes sending a transmission to the network and determining whether a response is received. In some example embodiments, the Medium Access Recovery Procedure defined in IEEE 802.11be may be used as the medium access recovery procedure. However, this procedure is not the only type of medium access recovery procedure that may be used with the example embodiments. The following provides a general outline of a medium access recovery procedure.

The station may perform a transmission on the medium when exiting the unavailable duration. The station may start a timer. In some examples, the timer may start from the end of the transmission if the transmission duration is greater than a threshold unless a timer has not expired. In other examples, the timer may be started when the station returns to the listening operation if a duration of the loss of medium synchronization is greater than threshold.

In some examples, the STA may not (re)start the timer if the transmission duration is less than or equal to a threshold. The threshold may be, for example, 72 μs but this is only an example. The value of 72 μs may be selected to cover at least the PPDU lengths of request to send (RTS)/clear to send (CTS)/Ack frames using a non-high throughput (non-HT) or non-HT duplicate PPDU format with a 6 Mb/s data rate, as well as the PPDU lengths of most typical BlockAck frames. The timer value may be set to any duration. In some examples, the timer value is set to a dot11MSDTimerDuration that is defined by standard.

If the station obtains a TXOP while the timer has a nonzero value (e.g., the timer is still running), the station may perform various operations for synchronization. If the station is a non-AP station, the station may transmit an RTS frame to an associated AP as the initial frame in an obtained TXOP. A threshold may be set for the CCA sensitivity in response to the RTS. The threshold may be, for example, the dot11MSDOFDMEDthreshold defined by standard. However. Other thresholds may be used. This may allow the station to detect a channel busy condition in the primary 20 MHz channel if the timer has a nonzero value.

If the station is an AP affiliated with a non-simultaneous transmit and receive (NSTR) mobile AP MLD, then the AP may transmits an RTS frame to an associated non-AP station as the initial frame in the TXOP. The station may not attempt to initiate a TXOP more than a predetermined amount of times since the start of the timer.

In other cases, the station may perform the CCA until the timer has expired before it initiates a transmission.

In a fifth aspect, the example embodiments are related to a triggered uplink (UL) Ack policy. For example, a non-AP station may send a High Efficiency (HE) Trigger Based (TB) PPDU in response to a trigger frame sent by an AP. The station may set an Ack policy indicator subfield of the QoS Data frames or QoS Null frames to indicate that the AP should return a normal Ack (e.g., BA) or an implicit BA response (BAR). However, when the station has an internal COEX (e.g., the station is unavailable for a period of time), the station may not receive the BA or BAR because it is unavailable. In this scenario, the station is not required to request the BA or BAR. This may be expressed as a non-AP STA that sends an HE TB PPDU as a response to a Basic Trigger frame may set the Ack Policy Indicator subfield of the QoS Data frames or QoS Null frames to Normal Ack or Implicit BAR, e.g., there is no requirement to set the Ack Policy Indicator subfield. In another example, a rule may be defined that if the station does not have an unavailability duration, the station may set the Ack Policy Indicator subfield to Normal Ack or implicit BAR or if the station has an unavailability duration, the station may not set the Ack Policy Indicator subfield to Normal Ack or implicit BAR.

In a sixth aspect, the example embodiments are related to transmission deferral due to COEX. In these example embodiments, a TXOP holder station that is transmitting may determine that a transmission cannot be performed due to COEX. However, if the TXOP holder station backoff expires, and the TXOP holder does not transmit due to a COEX event, the TXOP holder station may defer transmission by selecting a new random backoff counter using the present CW without advancing to the next value of the CW. The QSRC for the MAC Service Data Unit (MSDU) or aggregated MSDU (A-MSDU) is not affected. These example embodiments may prevent a collision in transmissions because multiple backoffs may have expired at the same time when there is a COEX issue.

In a seventh aspect, the example embodiments relate to operations performed by a TXOP holder station where the TXOP holder does not receive a response frame due to the unavailability duration indicated by a TXOP responder. In the example described above with reference to FIG. 6, the operations performed by the TXOP holder were described when the TXOP holder did not receive a BA from TXOP responder. In these example embodiments, these operations may be extended to any response frame that was not received due to the unavailability duration. These operations include the TXOP holder station not reducing the transmission rate and leaving the CW and QSRC for the access category (AC) unchanged.

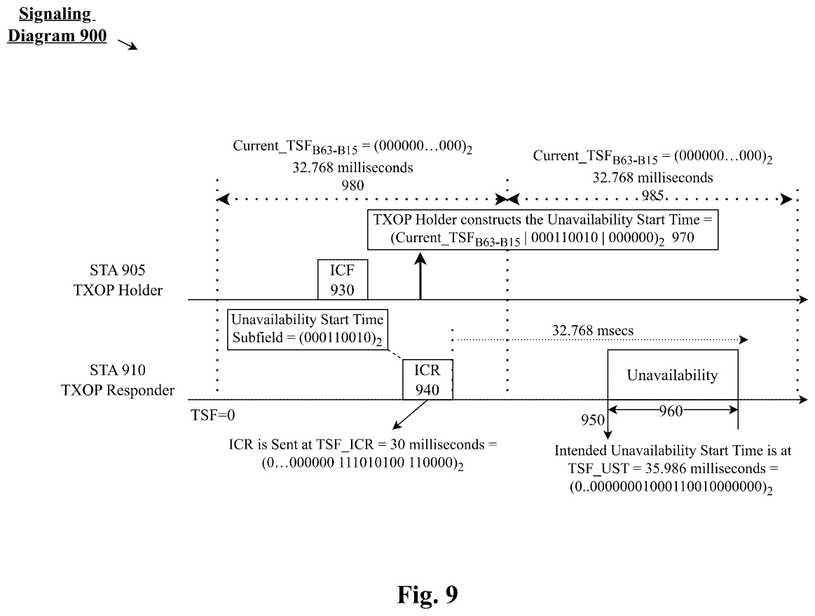

In an eighth aspect, the example embodiments are related to operation performed by the TXOP holder station to determine the unavailability start time for a TXOP responder. The issue associated with the unavailability start time and example solutions are described with reference to FIG. 9.

FIG. 9 shows an example signaling diagram 900 where the TXOP holder determines an unavailability start time based on information sent by the TXOP responder according to various example embodiments. The signaling diagram 900 is similar to the signaling diagram 300. The TXOP holder station 905 transmits an ICF 930. The TXOP responder station 910 transmits an ICR 940 in response to the ICF 930 that includes an unavailability start time 950 and an unavailability duration 960. Based on receiving the ICR 940 with the unavailability information, the TXOP holder station 905 may determine, in 970, the unavailability start time 950. However, issues may arise during the operation 970 when the TXOP holder station 905 constructs the unavailability start time 950.

For example, as shown in FIG. 9, the ICF 930 and the ICR 940 may occur during a first timing synchronization function (TSF) 980 but the unavailability start time 950 occurs during a second TSF 985. As shown in FIG. 9, values associated with the TSF are signaled in a 64 bit field, the 64 bit field may be split into various subfields. A first subfield may identify the TSF. The value identifying the TSF 980 includes the bits 15-63 shown in FIG. 9 as Current_TSF_{B63-B15}=(000000 . . . 000)₂. The value identifying the TSF 985 includes the bits 15-63 shown in FIG. 9 as Current_TSF_{B63-B15}=(000000 . . . 001)₂, e.g., in this example, the 15^{th} bit has been incremented to identify the next TSF.

A second subfield may provide the unavailability start time 950 as signaled in the ICR 940 and may comprise 9 bits, e.g., bits 6-14 of the 64 bit field. The use of 9 bits allows an identification of the unavailability start time 950 with a granularity of 64 microseconds (0, 64 μsecs, 128 μsecs, . . . ). This allows the unavailability start time subfield to indicate an unavailability start time up to 32.768 ms, which is the length of the TSF. This number of bits and the granularity are only examples and other numbers of bits for the subfields may be used.

When the TXOP responder station 910 sends the ICR 940 with including the unavailability start time 950, the TXOP responder station 910 may not send the entire 64 bit field but may only send the bits associated with the unavailability start time subfield, e.g., to save overhead. Thus, as shown in FIG. 9, the unavailability start time subfield in the ICR 940 may signal in the 9 bits (000110010)₂. The ICR 940 may be sent at a value of 30 ms and thus the TXOP responder station 910 intends that unavailability start time 950 is at the time shown in FIG. 9.

However, when the TXOP holder 905 constructs the unavailability start time from the information in the ICR 940, the TXOP holder may assume that the unavailability start time is in the TSF 980 and will calculate a time that is in the past, e.g., prior to the ICR 940. Thus, the TXOP holder 905 may not understand the unavailability start time is in the TSF 985 and therefore may not be able to perform the proper operations associated with unavailability duration.

In some example embodiments, the TXOP holder station 905 may determine whether the unavailability start time is in the current TSF 980 or in the next TSF 985. For example, the TXOP holder station 905 may compare the value in the unavailability start time subfield of the ICR 940 (e.g., bits 6-14) to the value in the current TSF 980 (e.g., bits 6-14). If the unavailability start time is greater than or equal to the current value in the TSF 980, the TXOP holder station 905 may determine that the unavailability start time is in the current TSF 980. On the other hand, if the unavailability start time is less than the current value in the TSF 980, the TXOP holder station 905 may determine that the unavailability start time is in the next TSF 985. In this manner, the TXOP holder station 905 may determine the unavailability start time 950 corresponding to the ICR 940.

In other example embodiments, the ICR 940 may include a further indication as to whether the unavailability start time applies to the current TSF or a next TSF. For example, the ICR 940 may include a next window bit that has a value of 0 when the unavailability start time applies to the current TSF or a value of 1 when the unavailability start time applies to the next TSF. In this manner, the TXOP responder station 910 explicitly indicates the TSF in which the unavailability duration 960 starts to the TXOP holder station 905. The next window bit may be a ne bit added to the ICR 940 or may be a bit from the current ICR that is repurposed.

Thus, the example embodiments provide various operations that may be performed by a TXOP holder or a TXOP responder to handle a scenario where the TXOP responder may be unavailable for a portion of the TXOP.

### EXAMPLES

In a first example, a method, comprising determining a transmission opportunity (TXOP) for transmitting to a station, processing, based on signaling received from the station, an indication comprising an unavailability start time and an unavailability duration that occurs during the TXOP and performing an operation related to the TXOP based on the indication.

In a second example, the method of the first example, wherein the operation comprises generating, for transmission to the station, a truncated physical layer protocol data unit (PPDU) comprising data that is less than all data to be transmitted to the station, wherein the truncated PPDU is transmitted to the station prior to the unavailability start time.

In a third example, the method of the second example, wherein the truncated PPDU is transmitted in time for the station to transmit a block acknowledgment (BA) prior to the unavailability start time.

In a fourth example, the method of the first example, wherein the operation comprises generating, for transmission to the station, a contention free (CF) end message terminating the TXOP.

In a fifth example, the method of the first example, wherein the operation comprises generating, for transmission to the station, a physical layer protocol data unit (PPDU) comprising data to be transmitted to the station, wherein the at least a portion of the PPDU is transmitted during the unavailability duration, determining the station did not acknowledge the PPDU and skipping altering transmission parameters for retransmission of the PPDU or further PPDUs.

In a sixth example, the method of the fifth example, wherein the transmission parameters comprise one of a transmission rate, a contention window (CW) size or a Quality of Service (QoS) retry counter (QSRC).

In a seventh example, the method of the first example, wherein the operation comprises scheduling transmissions to a second station during the unavailability duration.

In an eighth example, the method of the first example, further comprising determining a power mode or power state of the station prior to the unavailability start time and determining whether a frame comprising power information is received from the station during the unavailability duration.

In a ninth example, the method of the eighth example, further comprising, when the frame is not received, determining a power mode or power state of the station when the unavailability duration is completed is the power mode or power state of the station prior to the unavailability start time.

In a tenth example, the method of the eighth example, further comprising, when the frame is received, determining the station is in a power mode or power state indicated in the power information upon receipt of the frame.

In an eleventh example, the method of the tenth example, wherein the power mode indicated in the power information comprises an active power mode or a power save mode and the power state indicated in the power information comprises an awake state or a doze state.

In a twelfth example, the method of the eighth example, wherein the apparatus comprises a multiple link device (MLD) configured to maintain two or more links with the station.

In a thirteenth example, the method of the twelfth example, further comprising maintaining unavailability information for the station, wherein an unavailability state of the unavailability information applies to all of the two or more links with the station.

In a fourteenth example, the method of the twelfth example, further comprising maintaining an unavailability information for the station, wherein the unavailability information comprises an unavailability state corresponding to each of the two or more links.

In a fifteenth example, the method of the fourteenth example, wherein the indication comprising the unavailability start time and an unavailability duration further comprises an indication of the unavailability state of one of the two or more links to which the indication applies.

In a sixteenth example, the method of the fourteenth example, further comprising determining the unavailability state of one of the two or more links based on the indication being received on the one of the two or more links.

In a seventeenth example, the method of the first example, further comprising processing, based on signaling received from the station during the unavailability duration, an indication that a duration of the unavailability duration is changed.

In an eighteenth example, the method of the seventeenth example, wherein the indication that the duration of the unavailability duration is changed indicates the unavailability duration is canceled and the station is available.

In a nineteenth example, the method of the first example, further comprising processing, based on signaling received from the station, a physical layer protocol data unit (PPDU) received in response to a trigger frame, wherein the PPDU indicates that the apparatus is not required to send an acknowledgement in response to the PPDU.

In a twentieth example, the method of the first example, further comprising determining that a transmission backoff has expired for the TXOP during the unavailability duration and selecting a new transmission backoff to be applied after the unavailability duration, wherein the new transmission backoff is selected based on a current contention window of the TXOP.

In a twenty first example, the method of the first example, wherein the operation comprises generating, for transmission to the station, a frame to be transmitted to the station, wherein the at least a portion of the frame is transmitted during the unavailability duration, determining the station did not acknowledge the frame and skipping altering transmission parameters for retransmission of the frame or further frames.

In a twenty second example, the method of the twenty first example, wherein the transmission parameters comprise one of a transmission rate, a contention window (CW) size or a Quality of Service (QoS) retry counter (QSRC).

In a twenty third example, the method of the first example, wherein the indication comprises a number of bits indicating the unavailability start time, wherein the method further comprises comparing a time indicated by the number of bits of the indication to a time of a current timing synchronization function (TSF), when the time indicated by the number of bits is greater than or equal to the time of the current TSF, determining the unavailability start time is in the current TSF and, when the time indicated by the number of bits is less than the time of the current TSF, determining the unavailability start time is in a next TSF.

In a twenty fourth example, the method of the first example, wherein the indication comprises a number of bits indicating the unavailability start time and a further bit indicating whether the unavailability start time is in a current timing synchronization function (TSF) or a next TSF.

In a twenty fifth example, the method of the first example, wherein the indication comprising the unavailability start time and the unavailability duration is received in an initial control response (ICR).

In a twenty sixth example, the method of the twenty fifth example, wherein the ICR is received in response to an initial control frame (ICF) comprising information related to the TXOP that is transmitted by the apparatus.

In a twenty seventh example, the method of the first example, wherein the apparatus comprises one of an access point (AP) station or a non-AP station.

In a twenty eighth example, the method of the first example, wherein the station comprises a non-access point (AP) station.

In a twenty ninth example, a processor configured to perform any of the methods of the first through twenty eighth examples.

In a thirtieth example, a wireless communication device configured to perform any of the methods of the first through twenty eighth examples.

In a thirty first example, a method, comprising processing, based on signaling received from a station, an initial control frame (ICF) comprising information related to a transmission opportunity (TXOP) for the station, determining unavailability information comprising an unavailability start time and an unavailability duration that occurs during the TXOP and generating, for transmission to the station, an indication comprising the unavailability information.

In a thirty second example, the method of the thirty first example, wherein the unavailability duration comprises a value that is up to an availability duration or a value based on a duration of the TXOP in the ICF.

In a thirty third example, the method of the thirty first example, further comprising processing, based on signaling received from the station, a contention free (CF) end message terminating the TXOP, wherein the CF end message resets a network allocation vector (NAV).

In a thirty fourth example, the method of the thirty first example, further comprising generating, for transmission to the station during the unavailability duration, a frame comprising a power mode or power state of the apparatus.

In a thirty fifth example, the method of the thirty fourth example, wherein the power mode comprises an active power mode or a power save mode and the power state comprises an awake state or a doze state.

In a thirty sixth example, the method of the thirty first example, wherein the station maintains two or more links with the apparatus, and wherein the indication comprising the unavailability start time and an unavailability duration further comprises an indication of an unavailability state of one of the two or more links to which the indication applies.

In a thirty seventh example, the method of the thirty first example, further comprising generating, for transmission to the station during the unavailability duration, an indication that a duration of the unavailability duration is changed.

In a thirty eighth example, the method of the thirty seventh example, wherein the indication that the duration of the unavailability duration is changed indicates an unavailability is canceled.

In a thirty ninth example, the method of the thirty first example, further comprising determining synchronization has been lost with a medium based on the apparatus being unavailable during the unavailability duration and performing a synchronization recovery operation comprising performing a transmission with a network via the medium.

In a fortieth example, the method of the thirty ninth example, wherein the transmission is delayed a predetermined amount after an end of the unavailability duration when no frame is detected to a network allocation vector (NAV).

In a forty first example, the method of the thirty ninth example, wherein the synchronization recovery operation comprises a Medium Access Recovery Procedure defined by IEEE 802.11be.

In a forty second example, the method of the thirty first example, further comprising processing, based on signaling received from the station, a trigger frame and generating, for transmission to the station in response to the trigger frame, a physical layer protocol data unit (PPDU), wherein the PPDU indicates that the station is not required to send an acknowledgement in response to the PPDU.

In a forty third example, the method of the thirty first example, wherein the indication comprises a number of bits indicating the unavailability start time and a further bit indicating whether the unavailability start time is in a current timing synchronization function (TSF) or a next TSF.

In a forty fourth example, the method of the thirty first example, wherein the apparatus comprises one of an access point (AP) station or a non-AP station.

In a forty fifth example, the method of the thirty first example, wherein the station comprises an access point (AP) station.

In a forty sixth example, a processor configured to perform any of the methods of the thirty first through forty fifth examples.

In a forty seventh example, a wireless communication device configured to perform any of the methods of the thirty first through forty fifth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as ios, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry coupled to memory, wherein the processing circuitry is configured to:
determine a transmission opportunity (TXOP) for transmitting to a station;
process, based on signaling received from the station, an indication comprising an unavailability start time and an unavailability duration that occurs during the TXOP; and
perform an operation related to the TXOP based on the indication.

2. The apparatus of claim 1, wherein the operation comprises the processing circuitry being configured to:
generate, for transmission to the station, a truncated physical layer protocol data unit (PPDU) comprising data that is less than all data to be transmitted to the station, wherein the truncated PPDU is transmitted to the station prior to the unavailability start time.

3. The apparatus of claim 1, wherein the operation comprises the processing circuitry being configured to:
generate, for transmission to the station, a contention free (CF) end message terminating the TXOP.

4. The apparatus of claim 1, wherein the operation comprises the processing circuitry being configured to:
generate, for transmission to the station, a physical layer protocol data unit (PPDU) comprising data to be transmitted to the station, wherein the at least a portion of the PPDU is transmitted during the unavailability duration;
determine the station did not acknowledge the PPDU; and
skip altering transmission parameters for retransmission of the PPDU or further PPDUs.

5. The apparatus of claim 4, wherein the transmission parameters comprise one of a transmission rate, a contention window (CW) size or a Quality of Service (QoS) retry counter (QSRC).

6. The apparatus of claim 1, wherein the operation comprises the processing circuitry being configured to:
schedule transmissions to a second station during the unavailability duration.

7. The apparatus of claim 1, wherein the processing circuitry is further configured to:
determine a power mode or power state of the station prior to the unavailability start time; and
determine whether a frame comprising power information is received from the station during the unavailability duration.

8. The apparatus of claim 7, wherein the processing circuitry is further configured to:
when the frame is not received, determine a power mode or power state of the station when the unavailability duration is completed is the power mode or power state of the station prior to the unavailability start time.

9. The apparatus of claim 7, wherein the processing circuitry is further configured to:
when the frame is received, determine the station is in a power mode or power state indicated in the power information upon receipt of the frame.

10. The apparatus of claim 1, wherein the apparatus comprises a multiple link device (MLD) configured to maintain two or more links with the station.

11. The apparatus of claim 10, wherein the processing circuitry is further configured to:
maintain unavailability information for the station, wherein an unavailability state of the unavailability information applies to all of the two or more links with the station.

12. The apparatus of claim 10, wherein the processing circuitry is further configured to:
maintain an unavailability information for the station, wherein the unavailability information comprises an unavailability state corresponding to each of the two or more links.

13. An apparatus comprising processing circuitry coupled to memory, wherein the processing circuitry is configured to:
process, based on signaling received from a station, an initial control frame (ICF) comprising information related to a transmission opportunity (TXOP) for the station;
determine unavailability information comprising an unavailability start time and an unavailability duration that occurs during the TXOP; and
generate, for transmission to the station, an indication comprising the unavailability information.

14. The apparatus of claim 13, wherein the unavailability duration comprises a value that is up to an availability duration or a value based on a duration of the TXOP in the ICF.

15. The apparatus of claim 13, wherein the processing circuitry is further configured to:
process, based on signaling received from the station, a contention free (CF) end message terminating the TXOP, wherein the CF end message resets a network allocation vector (NAV).

16. The apparatus of claim 13, wherein the processing circuitry is further configured to:
generate, for transmission to the station during the unavailability duration, a frame comprising a power mode or power state of the apparatus.

17. The apparatus of claim 13, wherein the station maintains two or more links with the apparatus, and wherein the indication comprising the unavailability start time and an unavailability duration further comprises an indication of an unavailability state of one of the two or more links to which the indication applies.

18. The apparatus of claim 13, wherein the processing circuitry is further configured to:
generate, for transmission to the station during the unavailability duration, an indication that a duration of the unavailability duration is changed.

19. The apparatus of claim 13, wherein the processing circuitry is further configured to:
determine synchronization has been lost with a medium based on the apparatus being unavailable during the unavailability duration; and
perform a synchronization recovery operation comprising performing a transmission with a network via the medium.

20. The apparatus of claim 13, wherein the processing circuitry is further configured to:
process, based on signaling received from the station, a trigger frame; and
generate, for transmission to the station in response to the trigger frame, a physical layer protocol data unit (PPDU), wherein the PPDU indicates that the station is not required to send an acknowledgement in response to the PPDU.
